(19) United States
(12) Patent Application Publication
(10) Pub. No.: US 2005/0104500 A1
(43) Pub. Date: May 19, 2005

(54) Discharge lamp

(75) Inventors: Marco Haverlag, Eindhoven (NL); Robertus Antonius Johannes Keijser, Eindhoven (NL); Pascale Hepp, Turnhout (BE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/500,509

(22) PCT Filed: Dec. 20, 2002
(86) PCT No.: PCT/IB02/05671

(30) Foreign Application Priority Data
Jan. 4, 2002 (EP) 02075009.7

(51) Int. Cl. H01J 5/48; H01J 5/50

(52) U.S. Cl. 313/318.12; 313/318.01; 313/634

(57) ABSTRACT

The invention relates to a discharge lamp (1) having an outer bulb (2) that is provided with a lamp cap (3) at one end. The outer bulb encloses a discharge vessel (4) comprising electrodes, a first current conductor (5) and a second current conductor (6) arranged at some distance from the first current conductor, which current conductors establish an electric connection between the electrodes and the lamp cap. The shortest distance between the electrodes forms a discharge axis (40) of the discharge vessel. Part of the second current conductor (6) is placed substantially sidelong to the discharge axis. According to the invention, the second current conductor (6) comprises successive parts (7,8,9) arranged sidelong to the discharge axis and at mutually different distances from said axis.

The invention relates to a discharge lamp comprising an outer bulb, which outer bulb is provided with a lamp cap at one end, said outer bulb accommodating a discharge vessel provided with electrodes, and a first pole and a second pole at some distance from the first pole, which poles establish an electric connection between the lamp cap and the electrodes, at least a part of the second pole being mainly laterally positioned with respect to a discharge axis, and said discharge axis forming the shortest connection between the electrodes.

The discharge lamp mentioned in the opening paragraph has been known for many years from the prior art. An important drawback of the known discharge lamp resides in that a discharge channel present between the electrodes in the discharge vessel does not always extend in a straight line. When the discharge lamp is in operation, the discharge channel may be curved in shape, for example when the discharge lamp is operated in a vertical position. Said curved shape of the discharge channel can be attributed to the fact that the second pole which is laterally positioned with respect to the discharge vessel generates a tangential magnetic field during operation, causing a Lorentz force to be exerted on the charged particles forming the discharge channel. A drawback of the curved shape of the discharge channel resides in that it leads to a non-uniformly distributed thermal load on different parts of the discharge vessel, as a result of which the temperatures of different parts of the discharge vessel may differ substantially. The temperature gradient thus developed may lead to thermomechanical stress in parts of the discharge vessel, particularly in discharge vessels manufactured from a ceramic material. This physical effect may subsequently lead to a premature end of the service life of the lamp. The above negative effect is important, in particular, in discharge lamps that are arranged so as to be vertically positioned during operation, since to compensate a curved discharge channel use cannot be made of other compensating effects, such as a convective flow generated in the discharge vessel during the discharge.

French patent specification FR 779256 describes a discharge lamp of the type mentioned in the opening paragraph, wherein the second pole that is laterally positioned with respect to the discharge vessel is bilaterally positioned with respect to the discharge vessel. The second pole bifurcates into two diametrically opposite segments which are laterally arranged with respect to the discharge vessel, which segments, consequently, generate a substantially equally large, yet oppositely directed magnetic field at the location of the discharge channel. Consequently, the generated magnetic fields will substantially compensate each other in the discharge vessel. As the resultant magnetic field is thus minimized in the discharge vessel, no Lorentz force, or only a very small Lorentz force, will act on the charged particles, as a result of which the discharge channel is substantially rectilinearly positioned between the two electrodes in the discharge vessel. As a result, a substantial temperature gradient will normally be absent. The lamp is arranged to be, in particular, vertically oriented during operation. The device described in this publication, however, has a few drawbacks. A first drawback of the device described in said publication resides in that the second pole requires a double construction and hence is complex. This leads, inter alia, to the necessity of an additional number of welding points. Such a complex construction involves comparatively high manufacturing costs, while the manufacturing process is usually time consuming. In addition, as a result of said complex construction the risk of rejects during the production process is increased. A second drawback resides in that the construction of the device described is very critical. If the intended ratio of the electric resistors of the individual segments of the dual construction of the second pole is not accurately realized, for example as a result of imperfections in the welded joint, the current intensities through the individual segments of the second pole will not have the desired substantially equal value and, consequently, the intended compensating effect of the magnetic fields generated by the segments will not be achieved. The construction of the second pole is extremely critical, partly due to the reasons stated hereinabove, which is disadvantageous.

It is an object of the invention to provide a discharge lamp wherein the above-mentioned drawbacks are obviated.

To achieve this object, the invention provides a discharge lamp of the type mentioned in the opening paragraph, which is characterized in that the second pole is positioned unilaterally with respect to the discharge vessel, said second pole being shaped such that a magnetic field at the location of the discharge vessel is minimized. Since the resultant magnetic field in the discharge vessel is minimized by the shape of the second pole, curvature of the discharge channel in the discharge vessel occurs hardly or not at all. Consequently, the discharge channel will be substantially rectilinear. The design of the second pole is simple and does not require a complex and extensive manufacturing process, i.e. for example processing steps such as welding and soldering. The second pole, unlike the second pole in accordance with the prior art, can be manufactured in a single processing step. This advantage is desirable in particular in the case of lamps whose discharge vessel is mainly vertically oriented during operation, because in said position of the discharge vessel other compensating effects are absent.

The second pole is preferably provided with different, successive parts which are laterally positioned with respect to the discharge axis in the discharge vessel, which parts are spaced apart. The orientation of the parts with respect to each other is such that the resultant of the magnetic fields generated by the parts is only very small at the location of the discharge vessel. Preferably, the magnetic fields generated by the parts of the second pole extend in at least two opposite directions. This can be achieved, for example, by bending the second pole in a number of locations, thereby causing the magnetic fields generated by the individual parts to bend in the same direction. Thus, when the second pole is bent through 180°, a reversal of the magnetic field takes place.

In a preferred embodiment, the distance at which at least one part of the second pole is situated from the discharge vessel differs from the distance at which the other parts of the second pole are situated from said discharge vessel. This enables magnetic fields to be compensated in a simple way as, in general, it applies that the size of the magnetic field generated by a part at the location of the discharge vessel is inversely proportional to the distance between said part and the discharge vessel. The parts of the second pole are preferably positioned in such a manner with respect to each other that the following applies

$${\sum }_{i = 1}^{N} \frac{ni \cdot I}{di} \approx 0 ,$$

with N≧2 where:
ni=the direction of the magnetic field generated,
N=the number of parts of the second pole that are laterally arranged with respect to the discharge axis of the discharge vessel,
I=the intensity of the current flowing through the discharge channel in the operating state, and
di=the distance between a certain part of the second pole and the discharge axis of the discharge vessel.

As mentioned above, the direction of the magnetic field is determined by two discrete values of the current through the pole: −1 and +1. Preferably, N is an odd number, starting from N=3, in order to enable a simple construction of the discharge lamp.

The invention can be advantageously applied in a high-pressure discharge lamp with a metal filling in the discharge vessel, such as high-pressure mercury lamps and high-pressure sodium lamps. Other suitable metals are Th, Li, Zn, Sc and In. An example of the invention relates to a metal-halide lamp. Examples of metal halides that can be used as the filling constituent of the discharge vessel are NaI, TlI, InI, ScI₃, DyI₃, HoI₃, TmI₃, CeI₃, SnI₂, CaI₂, LiI, ThI₄ and SnCl₂ and mixtures thereof. As a result of the complex discharge cycle taking place in the metal-halide lamp, the measure in accordance with the invention can particularly advantageously be used in the metal-halide lamp to obtain a discharge channel during lamp operation which largely coincides with the discharge axis.

The invention will be explained with reference to a drawing.

In the drawing:

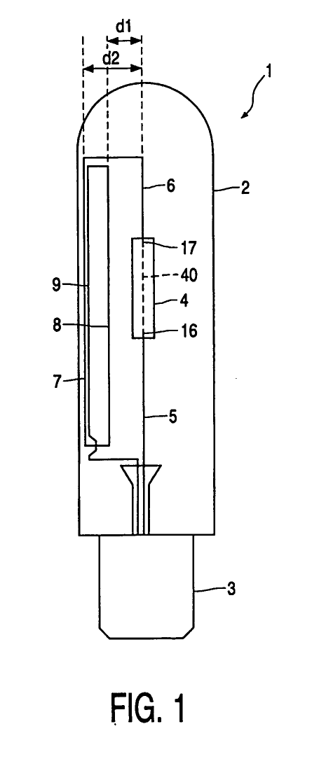

FIG. 1 is a side elevation of a discharge lamp in accordance with the invention,

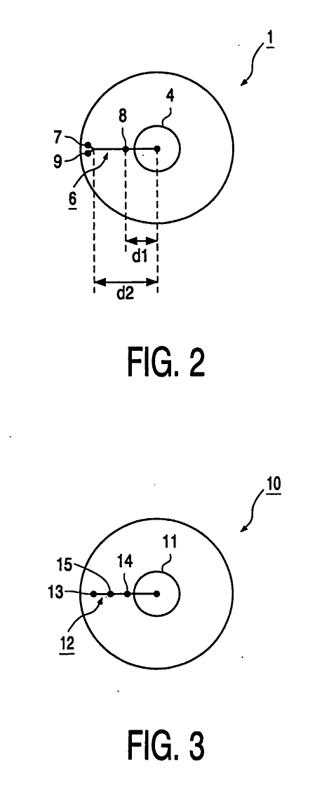

FIG. 2 is a plan view of the discharge lamp in accordance with FIG. 1, and

FIG. 3 is a plan view of a different preferred embodiment of a discharge lamp in accordance with the invention.

FIG. 1 is a side elevation of a discharge lamp 1 in accordance with the invention. Said discharge lamp 1 comprises an outer bulb 2, which outer bulb is provided at one end with a lamp cap 3. The outer bulb 2 is provided with a discharge vessel 4, a first pole 5 and a second pole 6 located at a distance from the first pole 5. The first pole 5 and the second pole 6 are connected to, respectively, a first electrode 16 and a second electrode 17. The electrodes 16, 17 are positioned in the discharge vessel 4, and, in the operating state of the lamp, a discharge channel (not shown) extends between said electrodes. The shortest connection between electrodes 16, 17 is formed by the discharge axis 40. The second pole 6 is provided with different parts 7, 8, 9 which are positioned laterally with respect to the discharge axis 40 of the discharge vessel 4. If an electric current flows through the second pole 6, the parts 7, 8, 9 generate a tangential magnetic field. As parts 7, 9 and part 8 generate magnetic fields which extend partly in opposite directions, compensation takes place at the location of the discharge vessel 4. The degree of compensation depends on the exact positioning of parts 7, 8, 9 with respect to the discharge vessel 4. In the case of an elongated conductor it applies that the size of the magnetic field, generated by the conductor, in a point at a distance d from the conductor is inversely proportional to the distance d. FIG. 1 shows the distance between parts 7, 9 and the discharge axis 40, which distance is referenced d2. FIG. 1 also shows the distance between part 8 and the discharge axis 40, which distance is referenced d1. FIG. 2 is a plan view of the discharge lamp 1 in accordance with FIG. 1. The discharge vessel 4 is connected to the second pole 6. In the case shown, the distance d2 is twice the distance d1. At such an orientation of the parts 7, 8, 9 of the second pole 6, the resultant magnetic field at the location of the discharge axis 40 is minimal as a result of substantially complete compensation. After all, as has been described hereinabove, superposition of magnetic fields in the discharge vessel 4 can be expressed as follows:

$${\sum }_{i = 1}^{N} \frac{ni \cdot I}{di} \approx 0 ,$$

with N≧2 where:
ni=the direction of the magnetic field generated
N=the number of parts of the second pole which are laterally positioned with respect to the discharge axis of the discharge vessel,
I=the intensity of the current flowing through the discharge channel in the operating state, and
di=the distance between a certain part of the second pole and the discharge axis of the discharge vessel.

If the result of this expression is 0, this means that the presence of magnetic fields on the discharge axis 40 of the discharge vessel 4 is reduced to a minimum. If this expression is applied to the discharge lamp shown in FIGS. 1 and 2, the following result is obtained:

$$\begin{matrix}{[ \frac{n}{d} ]}_{deel7} + {[ \frac{n}{d} ]}_{deel8} + {[ \frac{n}{d} ]}_{deel9} = \\ [ \frac{1}{2 {d}_{1}} ] + [ \frac{- 1}{{d}_{1}} ] + [ \frac{1}{2 {d}_{1}} ] = \\ [ \frac{1}{{d}_{1}} ] - [ \frac{1}{{d}_{1}} ] = 0\end{matrix}$$

In an ideal situation, the value of the expression is 0, which results in substantially complete compensation of the magnetic field in the discharge vessel.

As a result, the discharge is not brought out of position under the influence of a magnetic field generated in the second pole. It should be clear that the result of said expression depends only on the ratio between d1 and d2, not on the actual size of d1 and/or d2.

FIG. 3 is a plan view of a different embodiment of a discharge lamp 10 in accordance with the invention. Said discharge lamp 10 is composed of components similar to those used for the embodiment shown in FIGS. 1 and 2. Discharge vessel 11 is connected to a first pole (not shown) and a second pole 12. The second pole 12 is provided with three parts 13, 14, 15 which are positioned substantially laterally with respect to the discharge vessel 11. The shortest distances from the parts 13, 14, 15 to the discharge vessel 11 are in the ratio of 6x:2x:3x, respectively. If the above expression is used, the following applies:

$$\begin{matrix}{[ \frac{n}{d} ]}_{deel13} + {[ \frac{n}{d} ]}_{deel14} + {[ \frac{n}{d} ]}_{deel15} = \\ [ \frac{1}{6 x} ] + [ \frac{- 1}{2 x} ] + [ \frac{1}{3 x} ] = \\ [ \frac{1}{2 x} ] - [ \frac{1}{2 x} ] = 0\end{matrix}$$

As the result of the computation in question is 0, a minimum will lie, in the ideal case, on the discharge axis of the discharge vessel 11.

It will be clear that apart from the application of three parts of the second pole which are predominantly laterally positioned with respect to the discharge vessel, it is also possible, of course, that a plurality (more than three) parts of the second pole are laterally positioned with respect to the discharge vessel.

1. A discharge lamp comprising an outer bulb, which outer bulb is provided with a lamp cap at one end, said outer bulb accommodating:
a discharge vessel provided with electrodes, and
a first pole and a second pole at some distance from the first pole, which poles establish an electric connection between the lamp cap and the electrodes, at least a part of the second pole being mainly laterally positioned with respect to a discharge axis, said discharge axis forming the shortest connection between the electrodes,
characterized in that the second pole is positioned unilaterally with respect to the discharge vessel, said second pole being shaped such that a magnetic field at the location of the discharge vessel is minimized.

2. A discharge vessel as claimed in claim 1, characterized in that the second pole is provided with a number of successive parts which are laterally positioned with respect to the discharge axis in the discharge vessel, which parts are spaced apart.

3. A discharge lamp as claimed in claim 2, characterized in that the magnetic fields generated by the parts of the second pole are oriented in at least two directions.

4. A discharge lamp as claimed in claim 2, characterized in that the shortest distance between at least two parts and the discharge vessel is different.

5. A discharge vessel as claimed in claim 4, characterized in that the parts of the second pole are positioned in such a manner with respect to each other that the following applies:
$${\sum }_{i = 1}^{N} \frac{ni \cdot I}{di} \approx 0 ,$$
with (N≧0.2) where:
ni=the direction of the magnetic field generated,
N=the number of parts of the second pole that are laterally positioned with respect to the discharge axis of the discharge vessel,
I=the intensity of the current flowing through the discharge channel in the operating state, and
di=the shortest distance between a certain part of the second pole and the discharge axis of the discharge vessel.

6. A discharge vessel as claimed in claim 1, characterized in that the discharge vessel is embodied so as to be hermetical-tight, the discharge vessel accommodating at least one metallic element.

7. A discharge lamp as claimed in claim 6, characterized in that the metallic element forms part of a metal halide.

8. A discharge lamp as claimed in claim 1, characterized in that the outer bulb is provided with a diffuse layer.

9. A discharge lamp as claimed in claim 1, characterized in that the outer bulb is provided with a fluorescent layer.
